(19) United States
(12) Patent Application Publication
(10) Pub. No.: US 2013/0306336 A1
(43) Pub. Date: Nov. 21, 2013

(54) SOD ROLL COUNT SWITCH ASSEMBLY

(71) Applicant: Trebro Holding, Inc., Billings, MT (US)

(72) Inventor: Tom Shattuck, Dallas Center, IA (US)

(73) Assignee: Trebro Hoding, Inc., Billings, MT (US)

(21) Appl. No.: 13/896,297

(22) Filed: May 16, 2013

Related U.S. Application Data
(60) Provisional application No. 61/648,349, filed on May 17, 2012.

(51) Int. Cl. A01B 45/04

(52) U.S. Cl. CPC A01B 45/045
USPC 172/19

(57) ABSTRACT

A sod harvester comprising a roll count switch assembly that is maintained in a fixed position relative to the support frame and the conveyor belt assembly and that is not attached to and does not move with the ladder. The roll count switch assembly remains in a first position relative to the support frame and the conveyor belt assembly even while the ladder frame is translated between a first longitudinal position and a second longitudinal position.

### CROSS-REFERENCE TO RELATED APPLICATION

This application claims priority back to U.S. patent application Ser. No. 61/648,349 filed on May 17, 2012.

### BACKGROUND

1. Field of the Invention

The present invention relates generally to the field of sod harvesters and, more specifically, to a sod roll count switch assembly.

2. Description of the Related Art

A typical a sod harvester cuts a slab of sod and rolls each slab into a cylindrical roll. The sod rolls are then transferred to and stacked on a pallet for delivery. Various mechanized sod handling equipment is known in the prior art. Of particular interest here are mechanized devices for creating rolls from slabs of sod. For example, U.S. Pat. Nos. 6,296,063 and 6,364,027 both disclose sod rolling mechanisms. Typically, a sod roller includes a conveyor that transfers and rolls the sod slabs. A friction ladder is supported above the conveyor and the conveyor belt acts to roll each sod slab against the ladder. Sod rolls are accumulated in an array which is then stacked in layers of alternating rows and columns. A pick-and-place mechanism is used to pick the sod roll array and place it in a layer to form a stack. The layers of sod rolls are stacked on a pallet to facilitate transport to the location needing fresh sod.

In order for the sod harvester control system to determine when an array of sod rolls is ready for picking by the pick-and-place mechanism, a roll count switch is typically included in the sod roll mechanism. The location of the roll count switch is an important variable in the determination of whether a sod roll array is complete and ready for picking. In some applications it is desirable for the ladder to move with respect to the conveyor assembly. In such applications, the placement of the roll count switch is problematic as movement of the switch relative to the conveyor assembly can change the calibration of the harvester.

Accordingly, there is a need for a sod roll count switch assembly that remains in a fixed position relative to the conveyor assembly and sod rolling mechanism frame.

### BRIEF SUMMARY OF THE INVENTION

The present invention is a sod harvester comprising: a sod slab cutting assembly that feeds slabs of sod to a sod roll-up mechanism, wherein the sod roll-up mechanism comprises a conveyor belt assembly that works with a ladder assembly to roll up the sod slabs, and wherein the sod slabs are rolled up by friction caused between the conveyor belt assembly and the ladder assembly to form sod rolls; a pick-and-place assembly that picks up the sod rolls and places them at a first location; wherein the ladder assembly comprises a ladder and a support frame that is attached to the conveyor belt assembly; wherein a ladder frame is mounted in the support frame and is slideable in a longitudinal direction parallel to a direction of flow; wherein the a ladder is free to move up and down with respect to the conveyor belt assembly in order to allow the sod rolls to travel between the ladder and the conveyor belt assembly; and a sod roll-up switch assembly that detects when the sod rolls are rolled up and that is maintained in a fixed position relative to the support frame and the conveyor belt assembly and that is not attached to and does not move with the ladder.

In a preferred embodiment, the invention further comprises a roll count switch assembly, wherein the roll count switch assembly comprises a yoke; wherein the yoke is comprised of a pair of arms adjustably attached to a spar; wherein the spar is rotatably attached to a bracket; wherein the bracket is configured to slide along a guide rail; wherein the guide rail is attached to the ladder assembly; and wherein the yoke is attached to the support frame; wherein the bracket is maintained longitudinally relative to the support frame, and wherein the guide rail is configured to move back and forth with the ladder; and wherein the roll count switch assembly remains in a first position relative to the support frame and the conveyor belt assembly even while the ladder frame is translated between a first longitudinal position and a second longitudinal position. Preferably, the bracket supports a proximity sensor and an arm that hangs down in a path of the sod rolls as they flow into the pick-and-place assembly; wherein as each sod roll passes under the arm, the bracket lifts the arm, which in turn rotates a flag into view of the proximity sensor.

In an alternate embodiment, the invention further comprises a roll count switch assembly, wherein the roll count switch assembly comprises a support and assembly that supports a proximity sensor in a fixed position relative to the conveyor belt assembly and the support frame; wherein the support arm assembly comprises a shoulder bracket attached to the support frame; wherein the support frame rotates an upper arm; wherein upper arm is rotatably attached to a shoulder bracket at a shoulder joint; wherein the upper arm supports a lower arm via an elbow joint; wherein a bracket is supported by a wrist joint extending from a forearm; wherein the bracket supports the proximity sensor and a flag; wherein the flag is connected to a flapper arm that is pushed upward and into the range of the proximity sensor as sod rolls flow along the conveyor.

In another alternate embodiment, the invention comprises a roll count switch assembly, wherein the roll count switch assembly comprises a bracket; wherein the roll count switch assembly is supported in a fixed position relative to the support frame and the conveyor belt assembly by a support arm; wherein the bracket is rotatably attached to the support arm at a joint; wherein the bracket include a plurality of rollers that engage a pair of channels; wherein as the ladder assembly moves longitudinally; the rollers ride in and on channels and are supported thereby; wherein a proximity sensor is maintained in a fixed longitudinal position relative to the conveyor belt assembly; wherein the bracket supports the proximity sensor; wherein the proximity sensor senses a flag as sod rolls pass underneath the flag and urge the flag into a range of the proximity sensor.

### BRIEF DESCRIPTION OF THE DRAWINGS

The accompanying drawings, which are incorporated in and constitute a part of this specification, illustrate embodiments of a sod roll count switch assembly and together with the description, serve to explain the principles and operation thereof. Like items in the drawings are generally referred to using the same numerical reference.

FIG. 1 is a perspective view of an exemplary sod harvester that employs a sod roll count switch assembly according to a first exemplary embodiment;

FIG. 2 is an enlarged perspective view of the sod roll-up mechanism shown in FIG. 1;

FIG. 3 is a perspective schematic representation of the sod roll-up mechanism shown in FIGS. 1 and 2;

FIG. 4 is a prior art version of a sod roll count switch;

FIG. 5 is a perspective view of the sod roll count switch assembly shown in FIGS. 1-3;

FIG. 6 is an enlarged perspective view of the sod roll count switch assembly shown in a ready position with no sod rolls on the conveyor;

FIG. 7 is an enlarged perspective view of the sod roll count switch assembly shown with the flag in the active position;

FIG. 8 is a perspective view of the roll-up ladder assembly as viewed from the top with the ladder assembly in a first longitudinal position;

FIG. 9 is a perspective view of the roll-up ladder assembly as viewed from the top with the ladder assembly in a second longitudinal position;

FIG. 10 is a sod roll count switch assembly according to a second exemplary embodiment; and

FIG. 11 is a perspective view of a sod roll count switch assembly according to a third exemplary embodiment.

### DETAILED DESCRIPTION

Described herein is an improved sod roll count switch assembly that allows the sod roll count switch to remain in a fixed position relative to the conveyor assembly even as the longitudinal ladder position is adjusted.

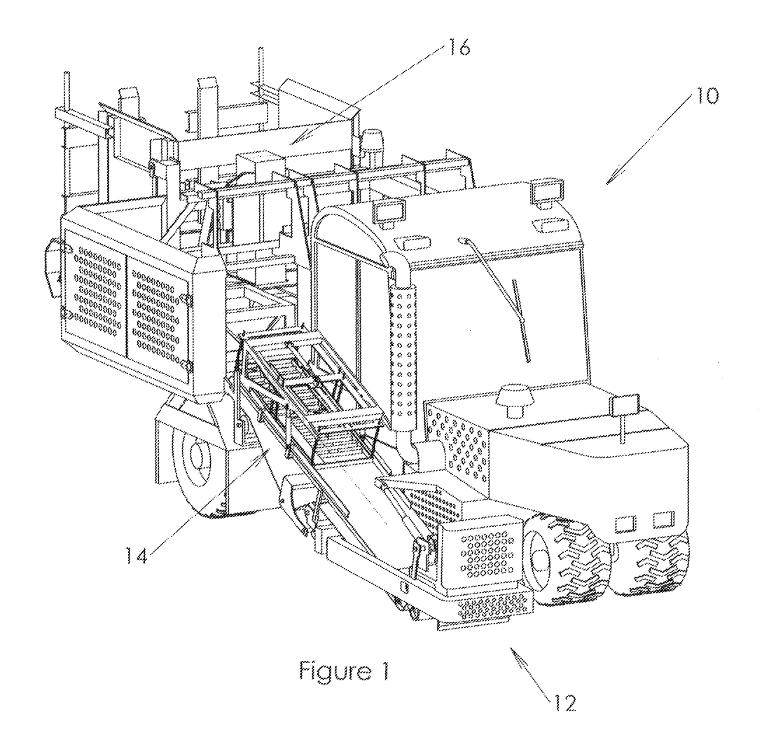

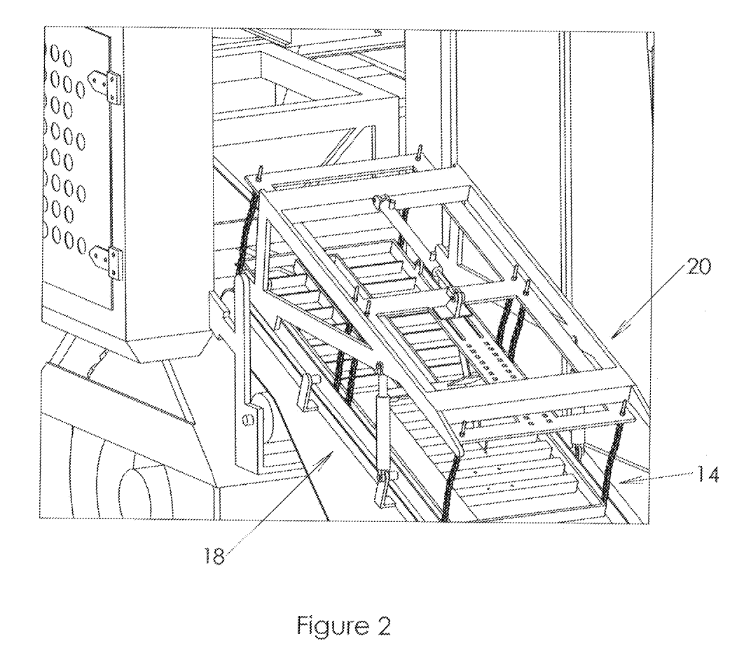

The sod harvester 10 shown in FIG. 1 includes a sod slab cutting assembly 12, which shaves slabs of sod from a field as shown and cuts them into selected lengths that are then fed into the sod roll-up mechanism 14. Once a number of sod rolls are accumulated from the sod roll-up mechanism 14, a pick-and-place assembly 16 picks up an array of sod rolls and places them on a pallet as is known in the art. With further reference to FIG. 2, the sod roll-up mechanism 14 includes a conveyor belt assembly 18 which works in conjunction with a ladder assembly 20 to roll up the sod slabs. The sod slabs are rolled up by friction caused between the conveyor 18 and the ladder assembly 14.

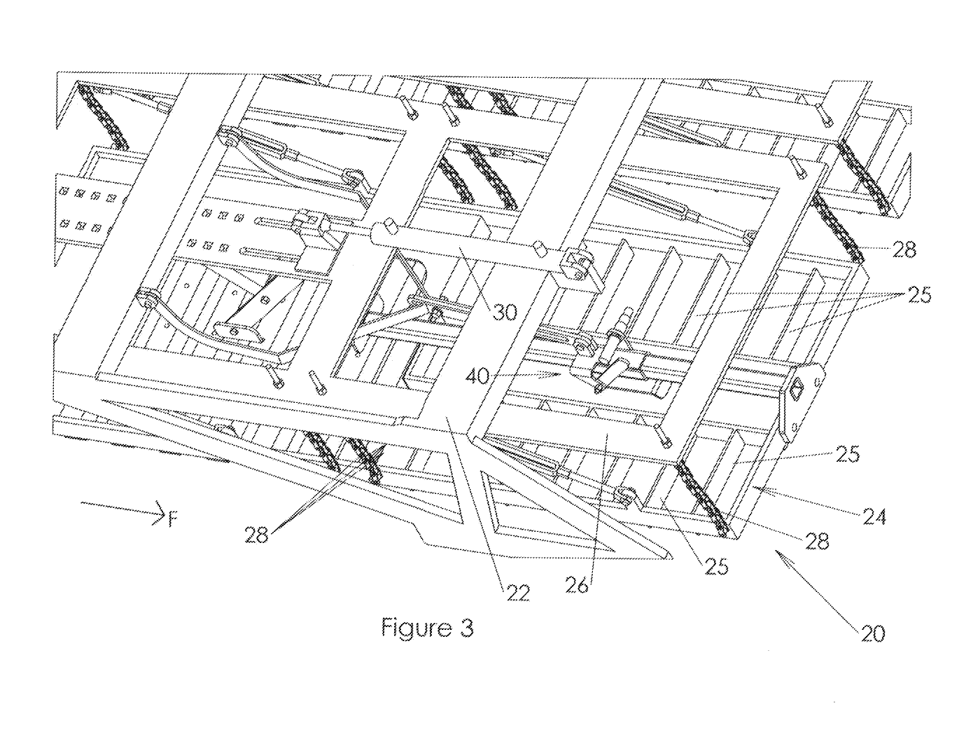

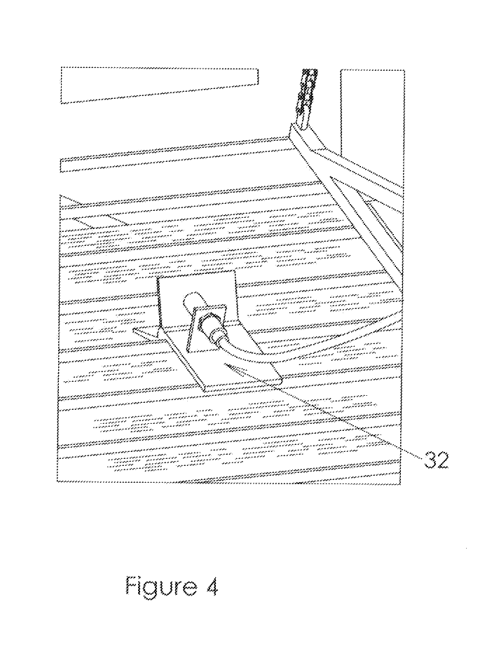

It can be appreciated with reference to FIG. 3 that ladder assembly 20 includes a support frame 22 which attaches to conveyor assembly 18 and supports ladder frame 26. Ladder frame 26 is mounted in support frame 22 such that it is slideable in a longitudinal direction parallel 10 the direction of flow F shown in FIG. 3. Ladder frame 26 supports the ladder 25 via a plurality of chains 28. Accordingly, each ladder is free to move up and down with respect to conveyor assembly 18 in order to allow sod rolls to travel between the ladder 24 and conveyor assembly 18. Ladder 24 includes a plurality of rungs 25 which are operative to engage the sod as it travels along conveyor assembly 18, thereby rolling the sod. Ladder frame 26 is translated longitudinally by cylinder 30 which attaches at one end to support frame 22 and to ladder frame 26 at the opposite end. It is desirable to be able to adjust the ladder assembly 20 back and forth in a longitudinal direction in order to adjust for different diameter sod rolls which may result from different thickness slabs or lengths of slabs. Although it is desirable to translate the ladder assembly 20 back and forth for adjustments, it is also desirable to maintain the sod roll-up switch 40 in a fixed position relative to support frame 22 and conveyor assembly 18. The roll-up switch assembly 40 is maintained in a fixed position relative to support frame 22 and conveyor 18 in order to consistently detect when the sod rolls are rolled up. As shown in FIG. 4, the prior art attached the sod roll-up switch 32 directly to the rungs of the ladder assembly. Therefore, the roll-up switch moved with the ladder as it was translated during adjustments. This prior art roll-up switch attachment was disadvantageous in some applications.

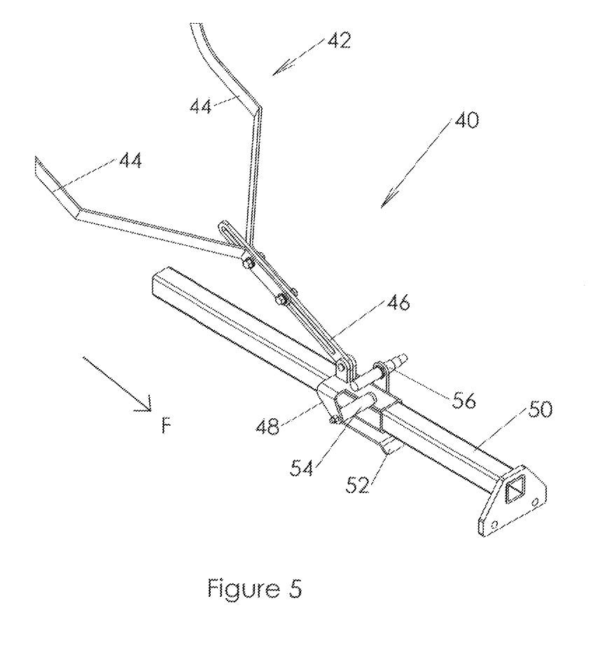

FIG. 5 illustrates the roll count switch 40 according to a first exemplary embodiment. Roll count switch assembly 40 includes a yoke 42 composed of a pair of arms 44 adjustably attached to a spar 46. Spar 46 is rotatably attached to a bracket 48. Bracket 48 is configured to slide along a guide rail 50. Guide rail 50 is attached to the ladder assembly while the yoke 42 is attached to support frame 22. Accordingly, the bracket 48 is maintained longitudinally relative to the support frame 22 while guide rail 50 may move back and forth with ladder 24 as it is adjusted. Bracket 48 supports a proximity sensor 56. Proximity sensor 56 may be a Hall Effect type sensor or other proximity sensor as is known in the art. Bracket 48 supports arm 52 which hangs down in the path of the sod rolls as they flow in direction F into the pick-and-place array former. Accordingly, as each sod roll passes under arm 52, it lifts arm 52 which in turn rotates flag 54 into the view of proximity sensor 56. In this case, as the sod roll contacts arm 52, it rotates flag 54 in a counterclockwise direction into the view of proximity sensor 56.

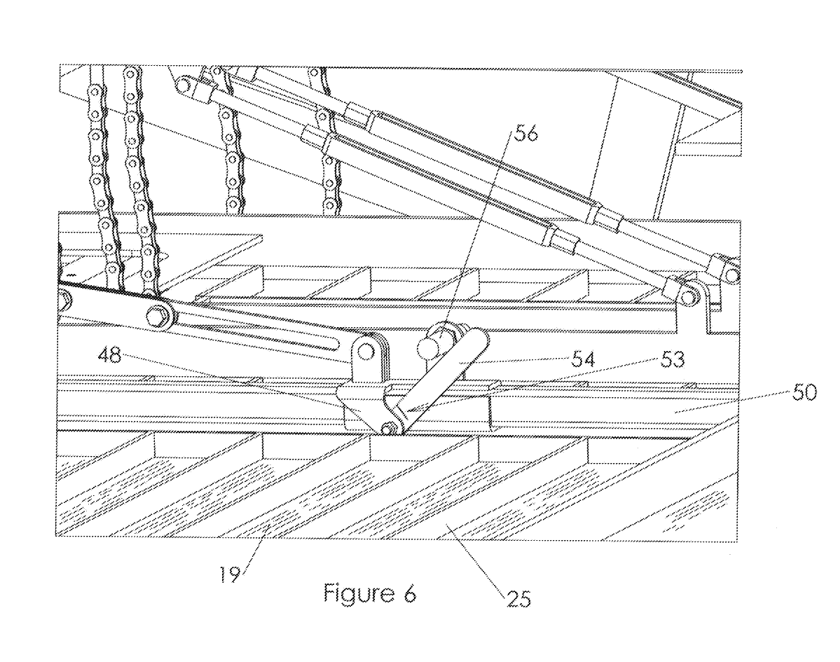

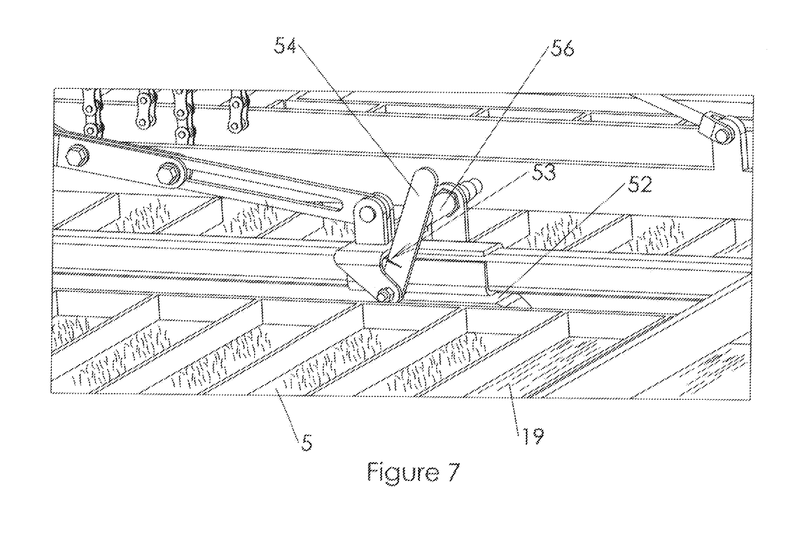

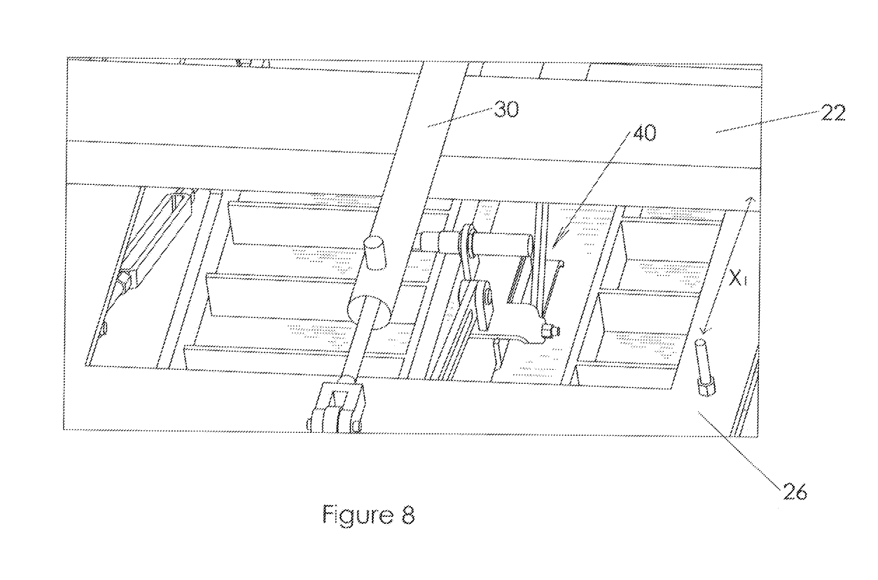

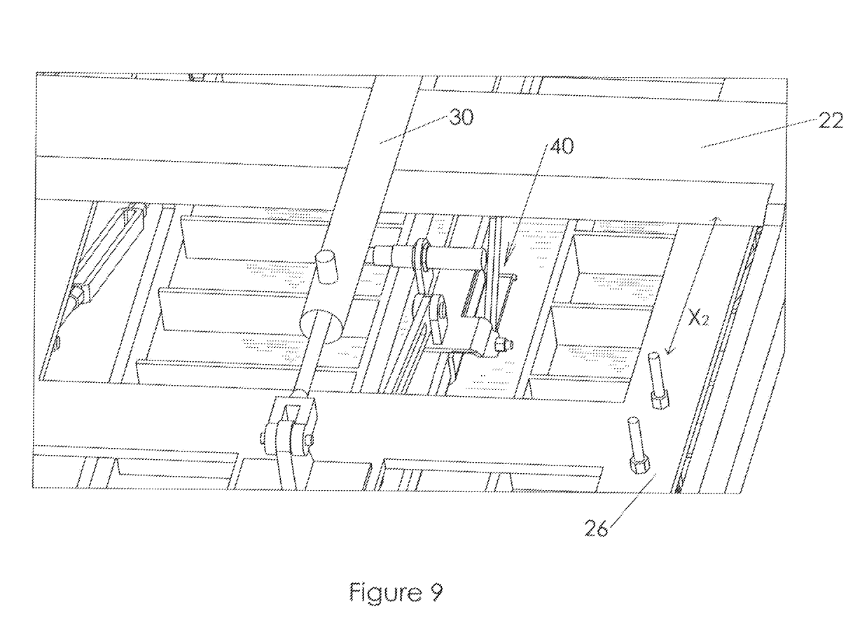

FIG. 6 illustrates the roll count switch assembly 40 in between sod rolls. Thus, there are no sod rolls between ladder rungs 25 and conveyor belt 19. Accordingly, flag 54 is not in view of proximity sensor 56. Also shown in FIG. 6, flag 54 is maintained in a clockwise position by spring 53 which, in this case, is in the form of a torsion spring 53. In FIG. 7, sod roll 5 has pushed arm 52 upward such that flag 54 rotates counterclockwise against spring 53 into the view of proximity sensor 56. Accordingly, the roll count switch assembly registers that a sod roll has passed the switch. With reference to FIGS. 8 and 9, it can be appreciated that the roll count switch assembly 40 remains in the same position relative to support frame 22 and conveyor assembly 18 even while ladder frame 26 is translated between a first longitudinal position X₁ and a second longitudinal position X₂.

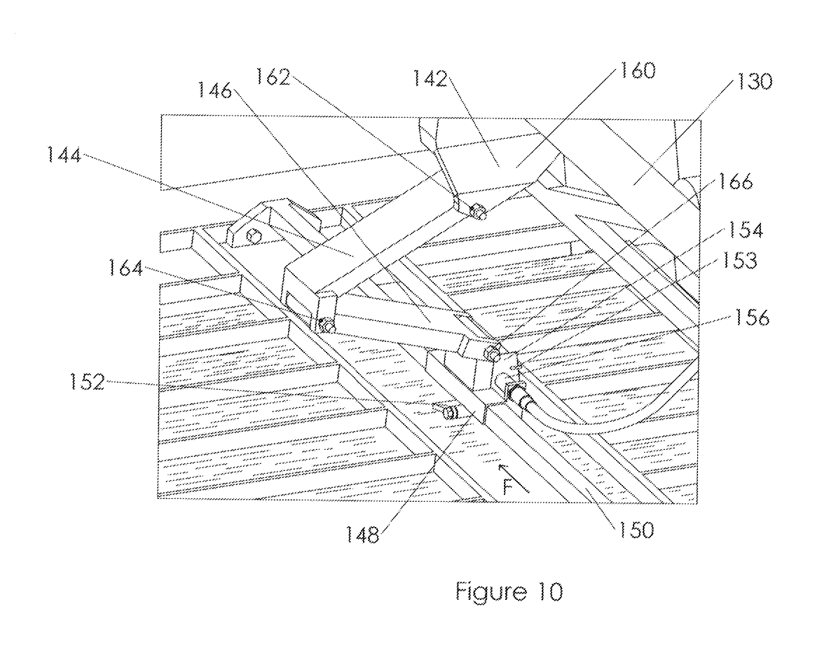

FIG. 10 illustrates a roll count switch assembly 140 according to a second exemplary embodiment. Roll count switch 140 includes a support arm assembly 142 which supports the proximity sensor 156 in a fixed position relative to the conveyor assembly and support frame. In this case, the proximity sensor 156 is supported in a fixed position by the support arm assembly 142. Support arm assembly 142 includes a shoulder bracket 160 attached to the support frame which, in turn, rotatably supports an upper arm 144. Upper arm 144 is rotatably attached to shoulder bracket 160 at a shoulder joint 162. Upper arm 144 supports lower arm 146 via an elbow joint 164. Bracket 148 is supported by a wrist joint 166 extending from forearm 146. Bracket 148 supports the proximity sensor 156 and a flag 154. Flag 154 is connected to flapper arm 152 which, as before, is pushed upward as sod rolls flow along the conveyor in direction F. In this case, flag 154 is maintained in an unsensed position by an extension spring 153. In this case, rather than flag 154 rotating into the view of proximity sensor 156, when sod rolls move arm 152 upward, flag 154 is moved into the range of proximity sensor 156. In other words, the flag 154 is too far away from the proximity sensor 156 until a sod roll moves the arm 152 and, in turn, flag 154 closer to proximity sensor 156. As shown, bracket 148 is sildeable along guide rail 150 which is attached to the ladder assembly.

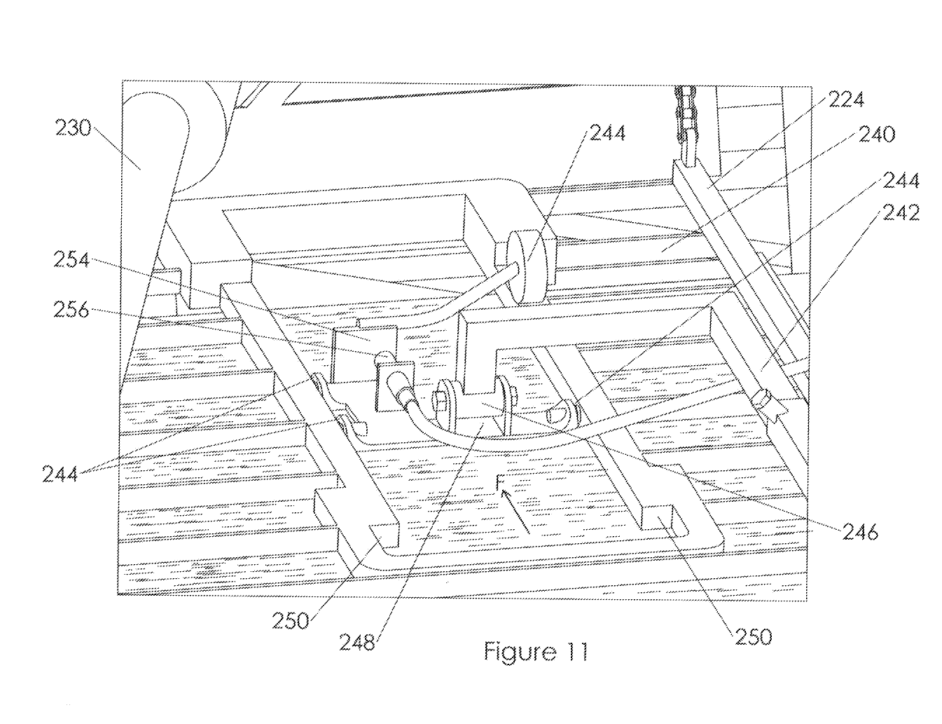

FIG. 11 illustrates a roll count switch assembly 240 according to a third exemplary embodiment. Roll count switch assembly 240 includes a bracket 248 and is supported in a fixed position relative to the support frame and conveyor belt assembly by a support arm 242. Bracket 248 is rotatably attached to support arm 242 at a joint 246 as shown. The bracket 248 includes a plurality of rollers 244 that engage a pair of channels 250. Accordingly, as the ladder assembly 224 moves longitudinally in the direction of flow F, the rollers 244 ride in and on channels 250 and are supported thereby. Thus, sensor 256 is maintained in a fixed longitudinal position relative to the conveyor assembly. Bracket 248 supports the proximity sensor 256 which senses flag 254 as sod rolls pass underneath flag 254, urging it into the range of proximity sensor 256.

Accordingly, the sod roll count switch assembly has been described with some degree of particularity directed to the exemplary embodiments. It should be appreciated, though, that modifications or changes may be made to the exemplary embodiments without departing from the inventive concepts contained herein.

I claim:

1. A sod harvester comprising:
a sod slab cutting assembly that feeds slabs of sod into a sod roll-up mechanism, wherein the sod roll-up mechanism comprises a conveyor belt assembly that works with a ladder assembly to roll up the sod slabs, and wherein the sod slabs are rolled up by friction caused between the conveyor belt assembly and the ladder assembly to form sod rolls;
a pick-and-place assembly that picks up the sod rolls and places them at a first location;
wherein the ladder assembly comprises a ladder and a support frame that is attached to the conveyor belt assembly;
wherein a ladder frame is mounted in the support frame and is slideable in a longitudinal direction parallel to a direction of flow;
wherein the ladder is free to move up and down with respect to the conveyor belt assembly in order to allow the sod rolls to travel between the ladder and the conveyor belt assembly; and
a roll count switch assembly that detects when the sod rolls are rolled up and that is maintained in a fixed position relative to the support frame and the conveyor belt assembly and that is not attached to and does not move with the ladder.

2. The sod harvester of claim 1, wherein the roll count switch assembly comprises a yoke; wherein the yoke is comprised of a pair of arms adjustably attached to a spar; wherein the spar is rotatably attached to a bracket; wherein the bracket is configured to slide along a guide rail; wherein the guide rail is attached to the ladder assembly; and wherein the yoke is attached to the support frame;
wherein the bracket is maintained longitudinally relative to the support frame, and wherein the guide rail is configured to move back and forth with the ladder; and
wherein the roll count switch assembly remains in a first position relative to the support frame and the conveyor belt assembly even while the ladder frame is translated between a first longitudinal position and a second longitudinal position.

3. The sod harvester of claim 2, wherein the bracket supports a proximity sensor and an arm that hangs down in a path of the sod rolls as they flow into the pick-and-place assembly; wherein as each sod roll passes under the arm, the bracket lifts the arm, which in turn rotates a flag into view of the proximity sensor.

4. The sod harvester of claim 1, wherein the roll count switch assembly comprises a support arm assembly that supports a proximity sensor in a fixed position relative to the conveyor belt assembly and the support frame; wherein the support arm assembly comprises a shoulder bracket attached to the support frame; wherein the support frame rotates an upper arm; wherein upper arm is rotatably attached to a shoulder bracket at a shoulder joint; wherein the upper arm supports a lower and via an elbow joint; wherein a bracket is supported by a wrist joint extending from a forearm; wherein the bracket supports the proximity sensor and a flag; wherein the flag is connected to a flapper arm that is pushed upward and into the range of the proximity sensor as sod rolls flow along the conveyor.

5. The sod harvester of claim 1, wherein the roll count switch assembly comprises a bracket; wherein the roll count switch assembly is supported in a fixed position relative to the support frame and the conveyor belt assembly by a support arm; wherein the bracket is rotatably attached to the support arm at a joint; wherein the bracket includes a plurality of rollers that engage a pair of channels; wherein as the ladder assembly moves longitudinally, the rollers ride in and on channels and are supported thereby; wherein a proximity sensor is maintained in a fixed longitudinal position relative to the conveyor belt assembly; wherein the bracket supports the proximity sensor; wherein the proximity sensor senses a flag as sod rolls pass underneath the flag and urge the flag into a range of the proximity sensor.
